(19) United States
(12) Patent Application Publication
(10) Pub. No.: US 2025/0136050 A1
(43) Pub. Date: May 1, 2025

(54) DUCT FOR DIRECTING WARM AIR TOWARD A WINDSHIELD WIPER

(71) Applicant: Dale Boegeman, Goshen, OH (US)

(72) Inventor: Dale Boegeman, Goshen, OH (US)

(21) Appl. No.: 18/383,958

(22) Filed: Oct. 26, 2023

(51) Int. Cl. B60S 1/04

(52) U.S. Cl. CPC B60S 1/0477

(57) ABSTRACT

An airflow diverting apparatus for facilitating heating a windshield wiper of an automobile includes a duct which is positionable on a dashboard of the automobile over a defroster vent of the automobile. The duct is shaped to direct air from the defroster vent to a portion of a windshield of the automobile closest to the windshield wiper.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to air-directing apparatuses and more particularly pertains to a new air-directing apparatus for facilitating heating a windshield wiper of an automobile.

### (2) Description of Related Art Including Information Disclosed Under 37 CFR 1.97 and 1.98

The prior art describes multiple apparatuses for directing warm air against a windshield to melt ice and snow which has accumulated on the windshield. The prior art also includes examples of apparatuses which direct heated air toward a portion of an automobile windshield proximate a windshield wiper to melt ice and snow which has accumulated particularly on the windshield wiper. For example, U.S. Pat. No. 4,549,471 describes a duct installed into a dashboard of the windshield which directs a first portion of flowing air upwardly toward the windshield and a second portion of flowing air toward a lower portion of the windshield proximate the windshield wiper. Also, U.S. Pat. No. 10,766,459 discloses an apparatus which mounts via suction cup to the windshield over a defroster vent and directs heated air from the defroster vent toward a low end of the windshield.

However, the prior art does not describe a duct shaped to be removably placed on the dashboard over the defroster vent to direct air from the defroster vent to a portion of the windshield closest to the windshield wiper. Such an apparatus would be advantageous over the prior art in that it allows heated air to be selectively directed toward the windshield wiper without obscuring an area above the apparatus by attaching to the windshield or risking leaving residue or other marks on the windshield via a suction cup. Such an apparatus would also comprise fewer parts of relatively simple to form shape which reduces a cost of manufacture. A removable device provides greater flexibility than a permanent duct system which always directs some air against the windshield above the windshield wiper and some air against the portion of the windshield immediately adjacent to the windshield wiper.

### BRIEF SUMMARY OF THE INVENTION

An embodiment of the disclosure meets the needs presented above by generally comprising a duct defining an interior space and comprising a base wall, a top wall, and a perimeter wall. The perimeter wall is coupled to and extends between the base wall and the top wall. The perimeter wall comprising a first section and a second section which are positioned opposite each other and a third section and a fourth section which are positioned opposite each other and extend between the first section and the second section.

The base wall has an inlet extending therethrough to the interior space. The duct is positionable such that the base wall is configured to support the duct on a dashboard of an automobile over a defroster vent of the automobile. The inlet is positioned such that the inlet is configured to be in fluid communication with the defroster vent when the base wall supports the duct on the dashboard. The top wall has an outlet extending therethrough to the interior space which is positioned adjacent to the first section of the perimeter wall of the duct. The outlet is positioned such that the outlet is configured to be positioned adjacent to a portion of a windshield of the automobile closest to a windshield wiper when the base wall supports the duct on the dashboard.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an airflow diverting apparatus according to an embodiment of the disclosure.

FIG. 2 is a bottom view of an embodiment of the disclosure.

FIG. 3 is a front view of an embodiment of the disclosure.

FIG. 4 is a side view of an embodiment of the disclosure.

FIG. 5 is a top view of an embodiment of the disclosure.

FIG. 6 is a bottom view of an embodiment of the disclosure.

FIG. 7 is a cross-section view of an embodiment of the disclosure taken from Arrows 7-7 in FIG. 5.

FIG. 8 is an in-use view of an embodiment of the disclosure.

### DETAILED DESCRIPTION OF THE INVENTION

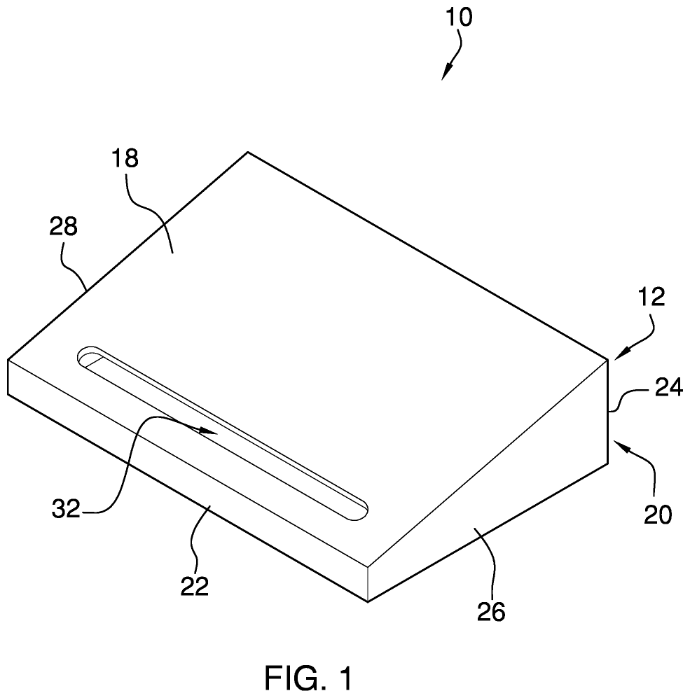

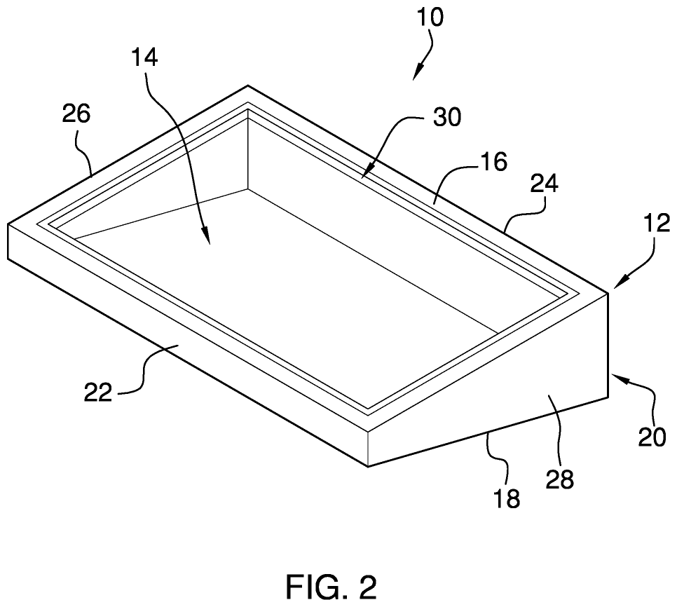

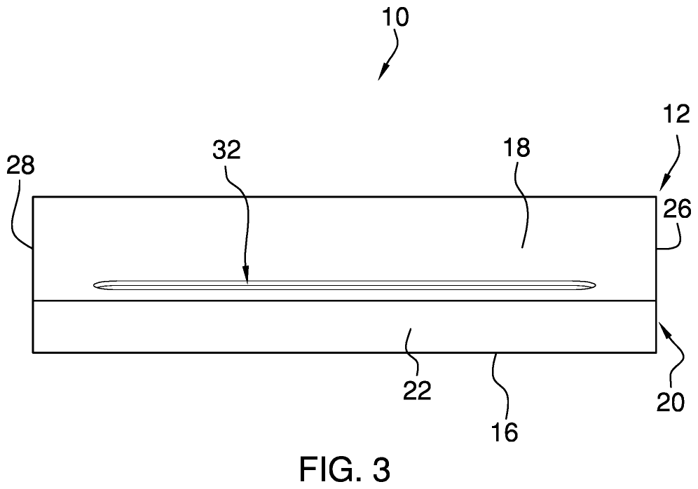

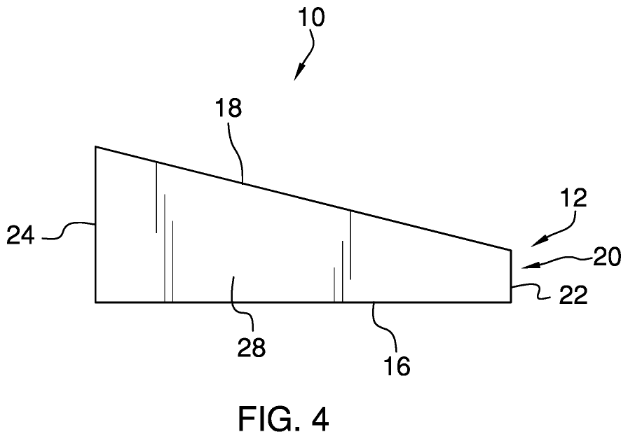

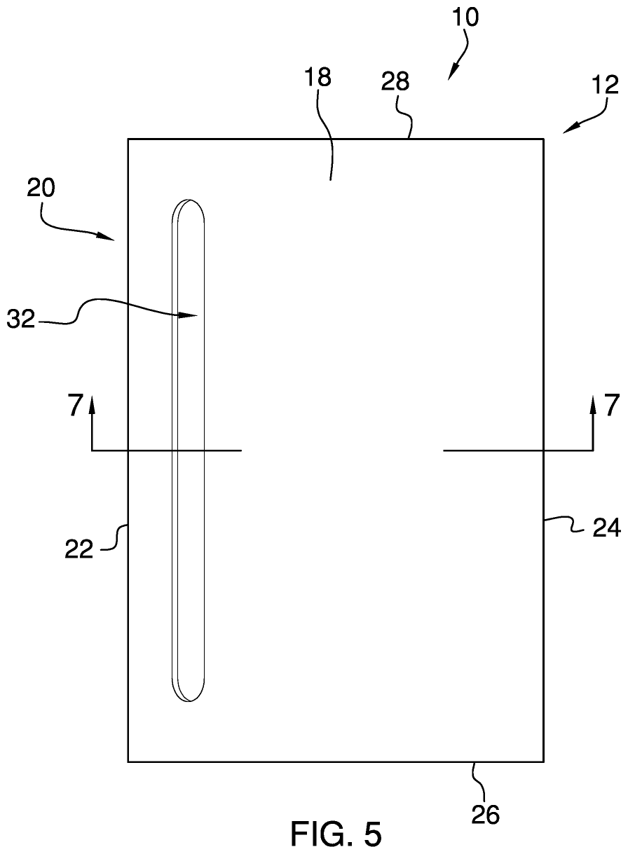

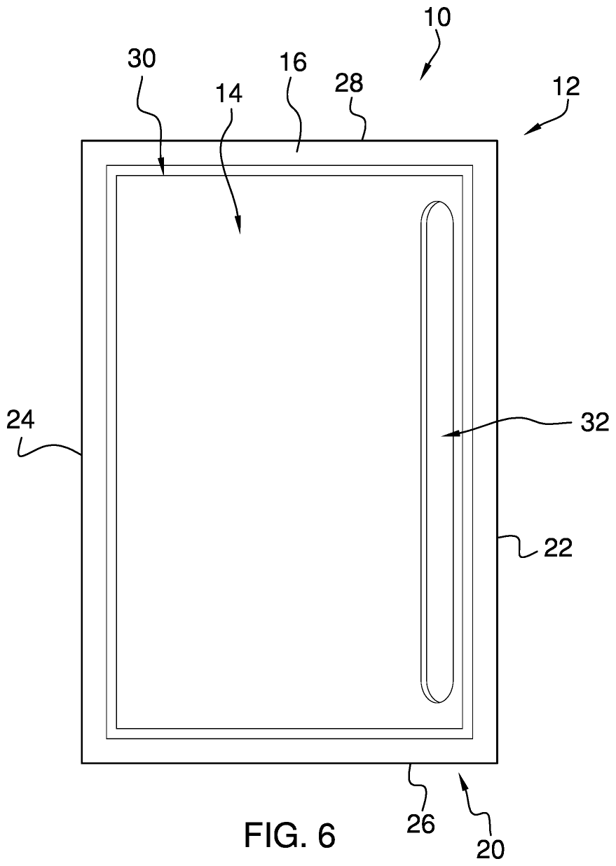

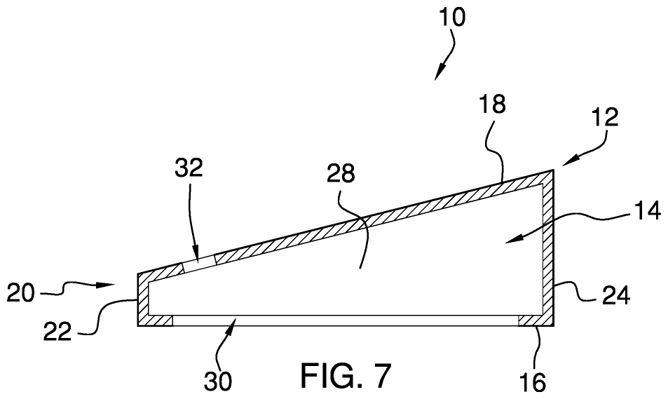

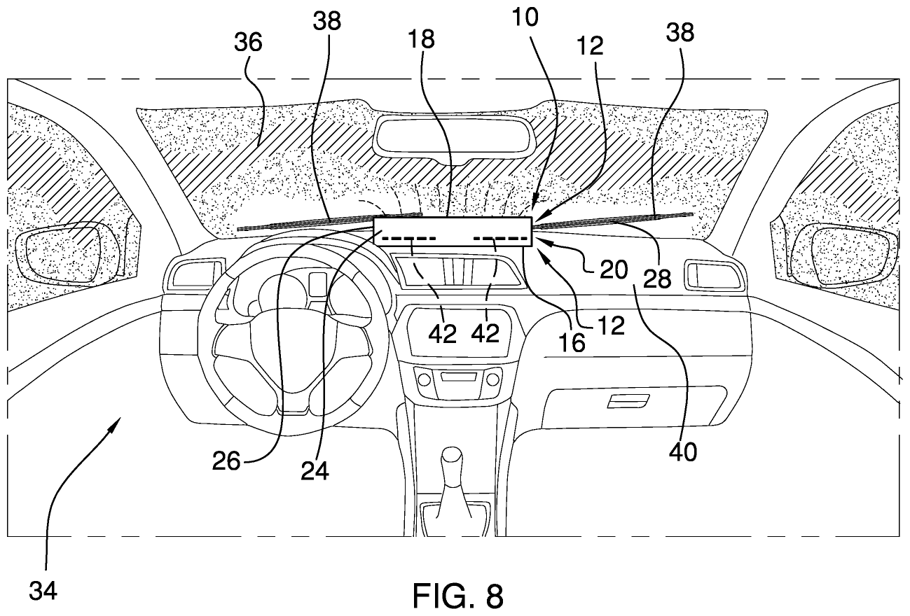

With reference now to the drawings, and in particular to FIGS. 1 through 8 thereof, a new air-directing apparatus embodying the principles and concepts of an embodiment of the disclosure and generally designated by the reference numeral 10 will be described.

As best illustrated in FIGS. 1 through 8, the airflow diverting apparatus 10 generally comprises a duct 12 defining an interior space 14 and comprising a base wall 16, a top wall 18, and a perimeter wall 18. The perimeter wall 18 is coupled to and extends between the base wall 16 and the top wall 18. The perimeter wall 18 comprises a first section 20 and a second section 22 which are positioned opposite each other. The perimeter wall 18 also comprises a third section 24 and a fourth section 26 which are positioned opposite each other and extend between the first section 20 and the second section 22.

A height of the first section 20 between the base wall 16 and the top wall 18 is less than a height of the second section 22 between the base wall 16 and the top wall 18 such that the top wall 18 is angled away from the base wall 16 from the first section 20 to the second section 22 of the perimeter wall 18. The height of the first section 20 is between 0.75 inches and 1.25 inches, and the height of the second section 22 is between 2.5 inches and 3.5 inches. The third section 24 and the fourth section 26 each have a width between the first section 20 and the second section 22 of between 5.75 inches and 12.25 inches. Each of the base wall 16, the top wall 18, and the perimeter wall 18 is integrally formed. The first section 20 is oriented parallel to the second section 22. The third section 24 is oriented parallel to the fourth section 26 and perpendicular to the first section 20 and the second section 22. The duct 12 has a rectangular cross-sectional shape parallel to the base wall 16.

The base wall 16 has an inlet 30 extending therethrough to the interior space 14. The duct 12 is positionable such that the base wall 16 is configured to support the duct 12 on a dashboard 40 of an automobile 34 over a defroster vent 42 of the automobile 34. The inlet 30 is positioned such that the inlet 30 is configured to be in fluid communication with the defroster vent 42 when the base wall 16 supports the duct 12 on the dashboard 40. An area of the inlet 30 is at least 90.0 percent of an area of the base wall 16, and the inlet 30 has a rectangular shape.

The top wall 18 has an outlet 32 extending therethrough to the interior space 14 which is positioned adjacent to the first section 20 of the perimeter wall 18 of the duct 12. The outlet 32 is positioned such that the outlet 32 is configured to be positioned adjacent to a portion of a windshield 36 of the automobile 34 closest to a windshield wiper 38 when the base wall 16 supports the duct 12 on the dashboard 40. A width of the outlet 32 is at least 75.0 percent of a width of the first section 20 of the perimeter wall 18 between the third section 24 and the fourth section 26. The outlet 32 is elongated along the width thereof and is oriented parallel to the first section 20 of the perimeter wall 18.

In use, the duct 12 is positioned on the dashboard 40 of the automobile 34 such that the inlet 30 is positioned over and in fluid communication with the defroster vent 42 and the outlet 32 is positioned adjacent to the portion of the windshield 36 closest to the windshield wiper 38. When a heater system of the automobile 34 is operated to direct heated air out of the defroster vent 42, the duct 12 directs the heated air against the portion of the windshield 36 adjacent to the windshield wiper 38, which is heated by the heated air and facilitates heat transfer to the windshield wiper 38. If ice accumulates on the windshield wiper 38 and bonds the windshield wiper 38 to the windshield 36, the duct 12 facilitates the melting of the ice to release the bond between the windshield wiper 38 and the windshield 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An airflow diverting apparatus for directing air flowing out of a defroster vent of an automobile toward a windshield wiper of the automobile, the apparatus comprising:
a duct defining an interior space and comprising a base wall, a top wall, and a perimeter wall, the perimeter wall being coupled to and extending between the base wall and the top wall, the perimeter wall comprising a first section and a second section which are positioned opposite each other, the perimeter wall comprising a third section and a fourth section which are positioned opposite each other and extend between the first section and the second section;
the base wall having an inlet extending therethrough to the interior space, the duct being positionable such that the base wall is configured to support the duct on a dashboard of the automobile over the defroster vent, the inlet being positioned such that the inlet is configured to be in fluid communication with the defroster vent when the base wall supports the duct on the dashboard; and
the top wall having an outlet extending therethrough to the interior space, the outlet being positioned adjacent to the first section of the perimeter wall of the duct, the outlet being positioned such that the outlet is configured to be positioned adjacent to a portion of a windshield of the automobile closest to the windshield wiper when the base wall supports the duct on the dashboard.

2. The apparatus of claim 1, wherein a height of the first section between the base wall and the top wall being less than a height of the second section between the base wall and the top wall such that the top wall is angled away from the base wall from the first section to the second section of the perimeter wall.

3. The apparatus of claim 2, wherein the height of the first section is between 0.75 inches and 1.25 inches, the height of the second section being between 2.5 inches and 3.5 inches.

4. The apparatus of claim 1, wherein the third section and the fourth section each have a width between the first section and the second section of between 5.75 inches and 12.25 inches.

5. The apparatus of claim 1, wherein each of the base wall, the top wall, and the perimeter wall are integrally formed.

6. The apparatus of claim 1, wherein the first section is oriented parallel to the second section, the third section being oriented parallel to the fourth section and perpendicular to the first section and the second section, wherein the duct has a rectangular cross-sectional shape parallel to the base wall.

7. The apparatus of claim 1, wherein an area of the inlet is at least 90.0 percent of an area of the base wall.

8. The apparatus of claim 1, wherein the inlet has a rectangular shape.

9. The apparatus of claim 1, wherein a width of the outlet being at least 75.0 percent of a width of the first section of the perimeter wall between the third section and the fourth section, the outlet being elongated along the width thereof.

10. The apparatus of claim 1, wherein the outlet is oriented parallel to the first section of the perimeter wall.

11. An airflow diverting apparatus for directing air flowing out of a defroster vent of an automobile toward a windshield wiper of the automobile, the apparatus comprising:
a duct defining an interior space and comprising a base wall, a top wall, and a perimeter wall, the perimeter wall being coupled to and extending between the base wall and the top wall, the perimeter wall comprising a first section and a second section which are positioned opposite each other, the perimeter wall comprising a third section and a fourth section which are positioned opposite each other and extend between the first section and the second section, a height of the first section between the base wall and the top wall being less than a height of the second section between the base wall and the top wall such that the top wall is angled away from the base wall from the first section to the second section of the perimeter wall, the height of the first section being between 0.75 inches and 1.25 inches, the height of the second section being between 2.5 inches and 3.5 inches, the third section and the fourth section each having a width between the first section and the second section of between 5.75 inches and 12.25 inches, each of the base wall, the top wall, and the perimeter wall being integrally formed, the first section being oriented parallel to the second section, the third section being oriented parallel to the fourth section and perpendicular to the first section and the second section, wherein the duct has a rectangular cross-sectional shape parallel to the base wall;
the base wall having an inlet extending therethrough to the interior space, the duct being positionable such that the base wall is configured to support the duct on a dashboard of the automobile over the defroster vent, the inlet being positioned such that the inlet is configured to be in fluid communication with the defroster vent when the base wall supports the duct on the dashboard, an area of the inlet being at least 90.0 percent of an area of the base wall, the inlet having a rectangular shape; and
the top wall having an outlet extending therethrough to the interior space, the outlet being positioned adjacent to the first section of the perimeter wall of the duct, the outlet being positioned such that the outlet is configured to be positioned adjacent to a portion of a windshield of the automobile closest to the windshield wiper when the base wall supports the duct on the dashboard, a width of the outlet being at least 75.0 percent of a width of the first section of the perimeter wall between the third section and the fourth section, the outlet being elongated along the width thereof, the outlet being oriented parallel to the first section of the perimeter wall.
